(19) United States
(12) Patent Application Publication
(10) Pub. No.: US 2015/0263427 A1
(43) Pub. Date: Sep. 17, 2015

(54) ANTENNA

(71) Applicant: Cambridge Silicon Radio Limited, Cambridge (GB)

(72) Inventor: Leslie David Smith, Ely Cambridgeshire (GB)

(73) Assignee: Cambridge Silicon Radio Limited, Cambridge (GB)

(21) Appl. No.: 14/206,160

(22) Filed: Mar. 12, 2014

(51) Int. Cl. H01Q 9/26; H01Q 19/10; H01Q 9/28

(52) U.S. Cl. CPC H01Q 9/26; H01Q 9/285; H01Q 19/108

(57) ABSTRACT

An antenna comprising: a folded dipole and a reflector positioned to reflect radiation emitted by the dipole that is incident on the reflector.

### TECHNICAL FIELD

The present invention relates to an antenna.

### BACKGROUND TO THE INVENTION

Some applications require an antenna with high directionality, that is to say a high gain in one direction, and low gain in opposite directions. For example, in a retail environment such as a supermarket, a retail tag may be deployed on a shelf to provide highly localised product information or advertising to compatible devices such as mobile telephones and the like. In such an indoor location application, the retail tag must be configured to transmit a signal to a user of the mobile telephone or other compatible device who is standing in an aisle in which the retail tag is deployed, without also transmitting a signal that could be detected by devices in adjacent aisles, as such transmissions could interfere with other retail tags deployed in the adjacent aisles. In such applications, a highly directional antenna is required in the retail tag, to minimise or at least reduce such “zone-bleeding”.

Typically retail tags use Bluetooth Low Energy technology. The antennas used in current Bluetooth® devices are usually designed to be omni-directional. Such antennas tend to be omni-directional in one plane and contain radiation nulls in opposite directions in another plane. Thus, in no plane do existing antennas provide high gain in one direction and low gain in an opposite direction.

Accordingly, a need exists in the art for a highly directional antenna that is suitable for use in applications requiring high antenna gain in one direction but low gain in opposite directions.

### SUMMARY OF INVENTION

According to a first aspect of the present invention there is provided an antenna comprising: a folded dipole and a reflector positioned to reflect radiation emitted by the dipole that is incident on the reflector.

The combination of the folded dipole and the reflector gives rise to a highly directional antenna having high gain in a first direction and low gain in a second direction that is opposite to the first direction. Additionally, the use of the reflector enables the terminal impedance to be tuned to an appropriate value, thereby obviating or reducing the need for an impedance matching network when the antenna is connected to a radio device.

The folded dipole may be configured to emit radiation in a first direction away from the reflector and in a second direction towards the reflector, and the reflector may be configured to reflect the radiation that is incident on it in the second direction away from the reflector, such that the reflected radiation travels in the first direction.

The folded dipole may comprise a bow-tie dipole.

The bow-tie dipole permits transmission in a broad range of frequencies, making the antenna suitable for use in a diverse range of applications which use different transmit frequencies.

In this case, the folded dipole may comprise substantially symmetrical electrically conductive first and second antenna elements and an electrically conductive third antenna element which electrically connects the first and second antenna elements.

The antenna may be substantially planar.

For example, the folded dipole may be formed of a conductive material provided on a substrate.

The substrate may be a printed circuit board (PCB) substrate.

A planar antenna, whether formed of a conductive material provided on a substrate such as a PCB substrate or otherwise, is straightforward to manufacture and small in size, and can thus be used in devices with small form factors.

The reflector may be a ground plane of the PCB.

Alternatively, the folded dipole may be formed from one or more conductive rods.

A balun may be provided for connecting the antenna to a radio device.

According to a second aspect of the invention there is provided an antenna comprising substantially symmetrical electrically conductive first and second antenna elements and an electrically conductive third antenna element which electrically connects the first and second antenna elements.

The antenna may further comprise a reflector positioned to impede radiation emitted by the first, second and third antenna elements from travelling in a first direction by reflecting radiation emitted by the dipole that is incident on the reflector.

The reflector may be configured to reflect the radiation that is incident on it in a second direction that is substantially opposed to the first direction.

The antenna may be substantially planar.

For example, the first, second and third antenna elements may be formed of a conductive material provided on a substrate.

The substrate may be a printed circuit board (PCB) substrate.

The reflector may be a ground plane of the PCB.

Alternatively, the first, second and third antenna elements may be formed from one or more conductive rods.

A balun may be provided for connecting the antenna to a radio device.

According to a third aspect of the invention there is provided a device comprising a radio device and an antenna according to the first aspect.

According to a third aspect of the invention there is provided a device comprising a radio device and an antenna according to the second aspect.

### BRIEF DESCRIPTION OF THE DRAWINGS

Embodiments of the invention will now be described, strictly by way of example only, with reference to the accompanying drawings, of which:

FIG. 1 is a schematic representation of an antenna;

FIG. 2 is a chart showing a measured two-dimensional radiation pattern for the antenna of FIG. 1; and

FIG. 3 is a chart showing a simulated three-dimensional radiation pattern for the antenna of FIG. 1.

### DESCRIPTION OF THE EMBODIMENTS

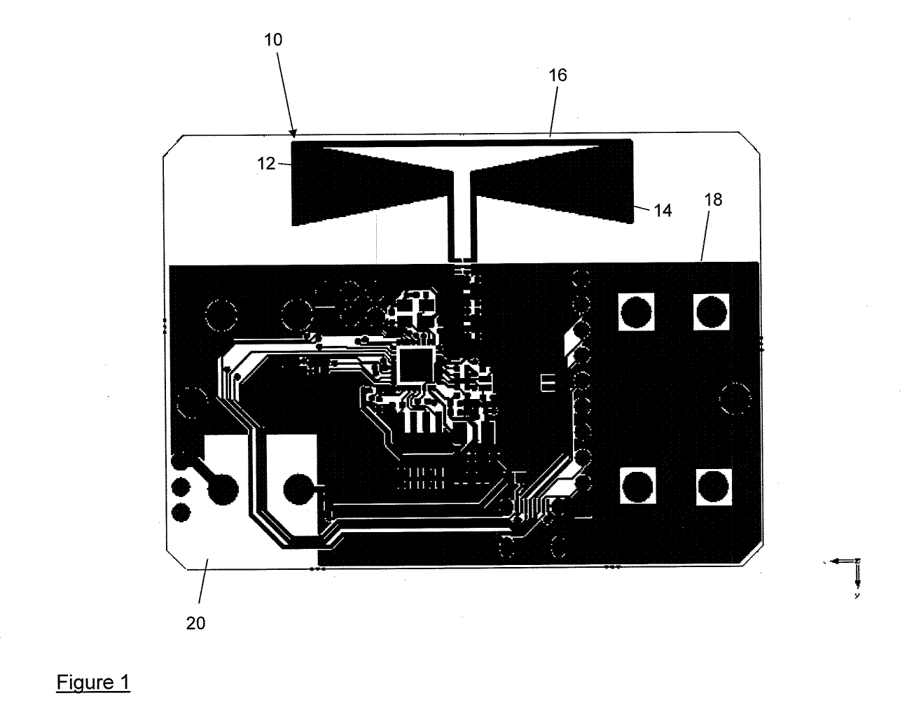

Referring first to FIG. 1, an antenna is shown generally at 10. The antenna 10 comprises first and second substantially symmetrical electrically conductive antenna elements 12, 14 which are connected by a third conductive antenna element 16 such that the first, second and third electrically conductive antenna elements 12, 14, 16 together form a folded dipole antenna. In the exemplary embodiment illustrated in FIG. 1, the folded dipole antenna takes the form of a folded bow-tie dipole. As will be understood by those skilled in the art, a bow-tie dipole is a form of dipole antenna which uses two opposed antenna elements which are thicker at their ends where the electric field is strongest. This thickening of the antenna elements at the ends creates a distinctive structure which resembles a bow-tie.

The third antenna element 16 electrically connects the first and second antenna elements 12, 14, thus changing the bow-tie configuration provided by the first and second antenna elements 12, 14 into a folded bow-tie configuration. This has the effect of increasing the terminal impedance of the antenna from about 70 ohms in the bow-tie configuration of the first and second antenna elements 12, 14 to about 300 ohms in the folded bowtie configuration which includes the first, second and third antenna elements 12, 14, 16.

In the exemplary embodiment illustrated in FIG. 1, the first, second and third antenna elements 12, 14, 16 are formed of an electrically conductive material such as copper deposited on a substrate, which in this example is the substrate of a printed circuit board (PCB). Thus, in the embodiment illustrated in FIG. 1, the antenna is substantially planar. However, it is to be understood that the first, second and third antenna elements 12, 14, 16 may be formed of other electrically conductive elements, such as electrically conductive rods.

The antenna 10 further includes a reflector 18, which in the embodiment illustrated in FIG. 1 is formed by an upper edge of a ground plane of a printed circuit board (PCB) 20 on which the antenna 10 is mounted. However, it will be appreciated that the reflector 18 may be formed from different types of electrically conductive structures. For example, the reflector 18 may be provided by an area or electrically conductive material deposited on the substrate of the PCB 20 that does not form part of the ground plane. Alternatively, the reflector 18 may be provided by an electrically conductive rod or the like.

The reflector 18 is configured to reflect radiation emitted by the antenna elements 12, 14, 16 to create a highly directional characteristic by reflecting radiation from the antenna elements 12, 14, 16 that is incident upon the reflector 18, thereby preventing the reflected radiation from travelling “beyond” the reflector 18.

The dipole formed by antenna elements 12, 14, 16 is substantially omni-directional in a plane perpendicular to an axis of the dipole, and so emits radiation equally in all directions. For the purposes of simplicity and clarity, the following discussion will assume that radiation is emitted by the dipole in a first direction, away from the reflector 18, and in a second direction, which is substantially opposite to the first direction, towards the reflector 18.

The reflector 18 is configured to reflect the radiation that is incident upon it, i.e. the radiation emitted by the dipole in the second direction. This reflected radiation is reflected away from the reflector 18 such that the reflected radiation travels in the first direction.

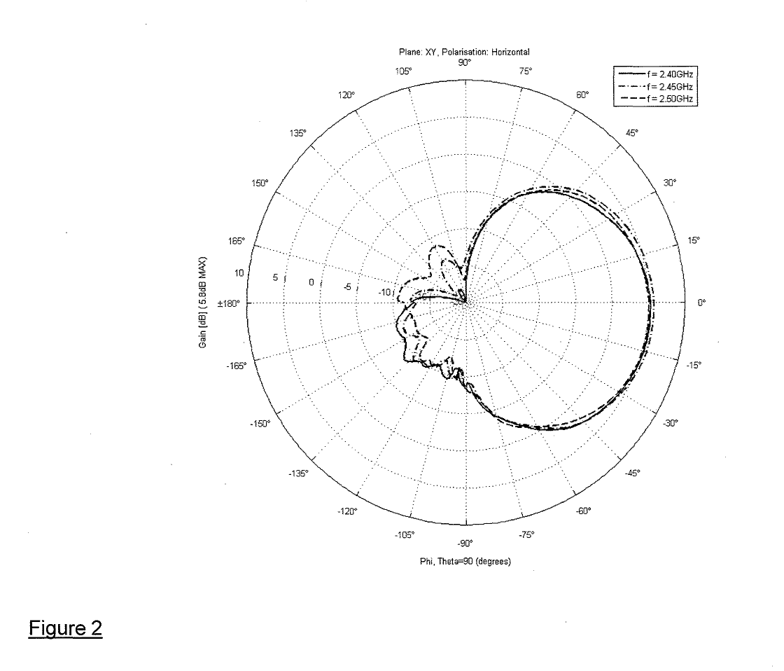

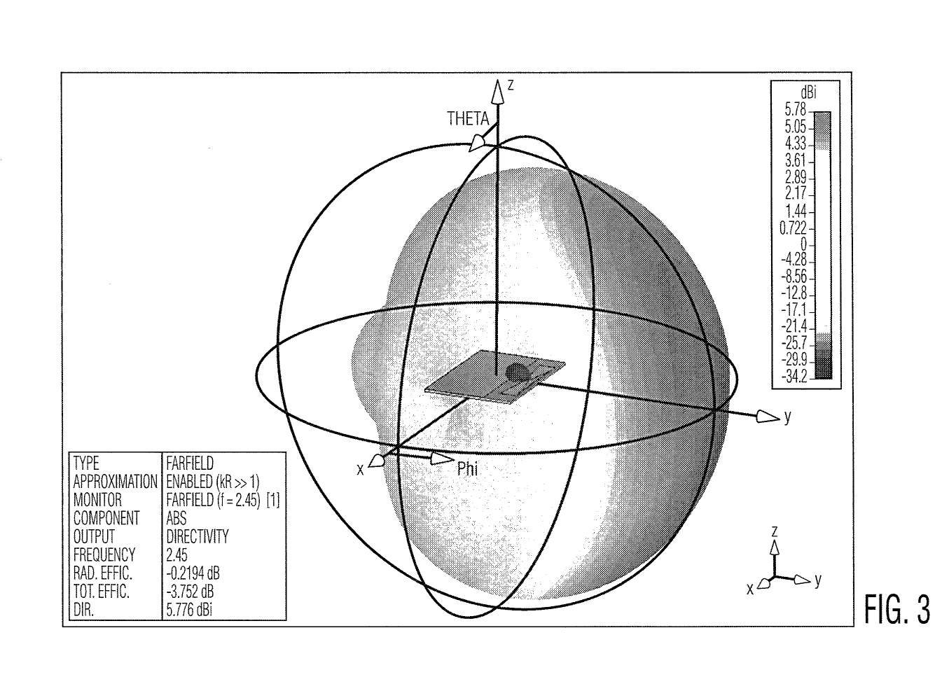

In this way, the antenna 10 can be made to have a high gain in one direction (i.e. the first direction, which is a direction opposite to a plane of the reflector 18) and a low gain in an opposite direction (i.e. the second direction). The measured two-dimensional radiation pattern for the antenna 10 shown in FIG. 2 illustrates this, showing that for transmitted signals with frequencies of 2.4, 2.45 and 2.5 GHz, the antenna 10 has a very high gain in a first direction (to the right of the chart of FIG. 2, between −90 and +90 degrees azimuth), and a significantly lower gain in a second direction (to the left of the chart of FIG. 2, between +90 and −90 degrees azimuth) that is opposite to the first direction. The simulated three-dimensional radiation pattern shown in FIG. 3 further illustrates this, showing a substantially hemispherical radiation pattern extending in a positive y direction, and no radiation in the opposite negative y direction.

The terminal impedance of the antenna 10 can be tuned according to the position of the reflector 18 with respect to the antenna elements 12, 14, 16. By placing the reflector 18 appropriately, the terminal impedance of the antenna 10 can be reduced to about 50 ohms, thereby facilitating connection of the antenna 10 to a radio device, as minimal matching of the terminal impedance of the antenna to the output impedance of the radio device will be required, in the sense that either no impedance matching network will be required in the radio device, or if an impedance matching network is required, it will be very simple and will contain few components. This helps to maintain a high efficiency in the antenna 10.

As the antenna 10 is a balanced structure, a differential balanced driving signal is required to drive it. In order to connect a radio device such as a Bluetooth® Low Energy radio device, which is typically a single-ended device, to the antenna 10, a balun may be used. The balun may be, for example, a discrete balun provided on the PCB 20, but it will be appreciated by those skilled in the art that alternative balun arrangements may also be used.

If additional “forward” gain (i.e. gain in the first direction) is required, one or more directors may be included in the antenna 10. These directors may be implemented, for example, as short traces of electrically conductive material on the PCB substrate 20 in front of the folded dipole formed from the first, second and third antenna elements.

Alternatively, the directors may be implemented using one or more electrically conductive rods.

As will be appreciated by those skilled in the art, the antenna described above provides an efficient and highly directional antenna that is suitable for use in any application where strong directionality is needed. In certain embodiments the antenna may be implemented as electrically conductive material deposited on a substrate such as a printed circuit board, which makes the antenna simple to manufacture and substantially planar in shape, facilitating its inclusion in small form-factor products. Additionally, minimal impedance matching is required for the antenna, which permits high efficiency of products which incorporate the antenna.

1. An antenna comprising:
a folded dipole and
a reflector positioned to reflect radiation emitted by the dipole that is incident on the reflector.

2. An antenna according to claim 1 wherein the folded dipole is configured to emit radiation in a first direction away from the reflector and in a second direction towards the reflector, and wherein the reflector is configured to reflect the radiation that is incident on it in the second direction away from the reflector, such that the reflected radiation travels in the first direction.

3. An antenna according to claim 1 wherein the folded dipole comprises a bow-tie dipole.

4. An antenna according to claim 3 wherein the folded dipole comprises substantially symmetrical electrically conductive first and second antenna elements and an electrically conductive third antenna element which electrically connects the first and second antenna elements.

5. An antenna according to claim 1 wherein the antenna is substantially planar.

6. An antenna according to claim 5 wherein the folded dipole is formed of a conductive material provided on a substrate.

7. An antenna according to claim 6 wherein the substrate is a printed circuit board (PCB) substrate.

8. An antenna according to claim 7 wherein the reflector is a ground plane of the PCB.

9. An antenna according to claim 1 wherein the folded dipole is formed from one or more conductive rods.

10. An antenna according to claim 1 further comprising a balun for connecting the antenna to a radio device.

11. An antenna comprising substantially symmetrical electrically conductive first and second antenna elements and an electrically conductive third antenna element which electrically connects the first and second antenna elements.

12. An antenna according to claim 11 further comprising a reflector positioned to impede radiation emitted by the first, second and third antenna elements from travelling in a first direction by reflecting radiation emitted by the dipole that is incident on the reflector.

13. An antenna according to claim 12 wherein the reflector is configured to reflect the radiation that is incident on it in a second direction that is substantially opposed to the first direction.

14. An antenna according to claim 11 wherein the antenna is substantially planar.

15. An antenna according to claim 14 wherein the first, second and third antenna elements are formed of a conductive material provided on a substrate.

16. An antenna according to claim 15 wherein the substrate is a printed circuit board (PCB) substrate.

17. An antenna according to claim 16 wherein the reflector is a ground plane of the PCB.

18. An antenna according to claim 11 wherein the first, second and third antenna elements are formed from one or more conductive rods.

19. An antenna according to claim 11 further comprising a balun for connecting the antenna to a radio device.

20. A device comprising a radio device and an antenna according to claim 1.

21. A device comprising a radio device and an antenna according to claim 11.
